(19) United States
(12) Patent Application Publication
(10) Pub. No.: US 2020/0404545 A1
(43) Pub. Date: Dec. 24, 2020

(54) METHOD FOR RESTRICTING CAPABILITY OF TERMINAL DEVICE, TERMINAL DEVICE, AND NETWORK DEVICE

(71) Applicant: GUANGDONG OPPO MOBILE TELECOMMUNICATIONS CORP., LTD., Dongguan, Guangdong (CN)

(72) Inventor: Ning YANG, Dongguan, Guangdong (CN)

(21) Appl. No.: 16/754,017

(22) PCT Filed: Oct. 18, 2017
(86) PCT No.: PCT/CN2017/106759

§ 371 Date: Apr. 6, 2020

(51) Int. Cl. H04W 28/18; H04W 72/12; H04W 74/00; H04W 74/08; H04W 8/24; H04M 1/725

(52) U.S. Cl. CPC H04W 28/18; H04W 72/1284; H04M 1/72577; H04W 74/0833; H04W 8/245; H04W 74/002

(57) ABSTRACT

Disclosed in the present application are a method for restricting a capability of a terminal device, the terminal device, a network device, and a computer storage medium. The method comprises: when a capability of a terminal device needs to be restricted, sending a restricted capability request of the terminal device to a network side; receiving an instruction that allows the terminal device to use the restricted capability and that is replied by the network side; and sending at least one kind of restricted capability information to the network side according to the instruction that allows the terminal device to use the restricted capability.

### TECHNICAL FIELD

Embodiments of the present disclosure generally relate to information process technologies, and more particularly, to a terminal device capability limiting method, a terminal device, a network device and a computer storage medium.

### BACKGROUND

Currently, with the pursuit of speed, low latency, high-speed mobility, energy efficiency, and the diversity and complexity of services in the future, the 3GPP International Standards Organization has started to develop 5G. In the early deployment of NR, complete NR coverage is difficult to obtain, so typical network coverage is wide-area LTE coverage and NR island coverage mode.

The terminal device capability acquisition in NR is based on the UE request and reporting. From the perspective of the terminal device, when the terminal device encounters interference from other bands, overheating, battery consumption, and so on, the terminal device temporarily changes its capabilities and reports to the base station, requiring the base station to use the restricted terminal device capability information. Reducing the capability of the terminal device can alleviate the above problems, which is beneficial and meaningful to the UE. However, if the terminal device autonomously modifies the capability information, it may cause problems such as device instability, unpredictable UE behavior, additional signaling load, and user complaints.

### SUMMARY

In order to solve the above technical problems, embodiments of the present disclosure provide a terminal device capability limiting method, a terminal device, a network device and a computer storage medium.

An embodiment of the present disclosure provides a terminal device capability limiting method, applied to a terminal device and including:

when the terminal device needs to limit a capability, sending a request for a limited capability of the terminal device to a network side;

receiving an instruction from the network side that allows the terminal device to use the limited capability; and

sending information about at least one type of limited capability to the network side based on the instruction that allows the terminal device to use the limited capability.

An embodiment of the present disclosure provides a terminal device capability limiting method, applied to a network device and including:

receiving a request for a limited capability reported by a terminal device;

sending to the terminal device an instruction that allows the terminal device to use the limited capability; and

receiving information about at least one type of limited capability reported by the terminal device.

An embodiment of the present disclosure provides a terminal device, including:

a first communication unit configured to, when the terminal device needs to limit a capability, send a request for a limited capability of the terminal device to a network side, and receive an instruction from the network side that allows the terminal device to use the limited capability; and

a first process unit configured to send information about at least one type of limited capability to the network side via the first communication unit based on the instruction that allows the terminal device to use the limited capability.

An embodiment of the present disclosure provides a network device, including:

a second communication unit configured to receive a request for a limited capability reported by a terminal device, send to the terminal device an instruction that allows the terminal device to use the limited capability; and receive information about at least one type of limited capability reported by the terminal device.

An embodiment of the present disclosure provides a terminal device, including:

a processor; and

a memory for storing computer programs executable by the processor,

wherein when the processor executes the computer programs, steps of the above methods are implemented.

An embodiment of the present disclosure provides a network device, including:

a processor; and

a memory for storing computer programs executable by the processor,

wherein when the processor executes the computer programs, steps of the above methods are implemented.

An embodiment of the present disclosure provides a computer storage medium, wherein the computer storage medium stores computer-executable instructions, and when the computer-executable instructions are executed, steps of the above methods are implemented.

In the technical solutions of embodiments of the present disclosure, the terminal device requests to use temporarily restricted UE capability information, and then reports the temporarily restricted capability information to the network side, so that subsequent processing is triggered on the network side. Thus, embodiments of the present disclosure can achieve power conservation and interference avoidance for the terminal device.

### BRIEF DESCRIPTION OF THE DRAWINGS

FIG. 1 is a schematic flowchart 1 of a terminal device capability limiting method according to an embodiment of the present disclosure.

FIG. 2 is a schematic diagram of an information format according to an embodiment of the present disclosure.

FIG. 3 is a schematic flowchart 2 of a terminal device capability limiting method according to an embodiment of the present disclosure.

FIG. 4 is a schematic flowchart 3 of a terminal device capability limiting method according to an embodiment of the present disclosure.

FIG. 5 is a schematic flowchart 4 of a terminal device capability limiting method according to an embodiment of the present disclosure.

FIG. 6 is a schematic structural diagram of a terminal device according to an embodiment of the present disclosure.

FIG. 7 is a schematic structural diagram of a network device according to an embodiment of the present disclosure.

FIG. 8 is a schematic diagram of a hardware architecture according to an embodiment of the present disclosure.

### DETAILED DESCRIPTION

In order to understand the features and technical contents of the embodiments of the present disclosure in more detail, embodiments of the present disclosure will be described in detail with reference to the accompanying drawings. The drawings are provided for illustration only and are not intended to limit the embodiments of the present disclosure.

### First Embodiment

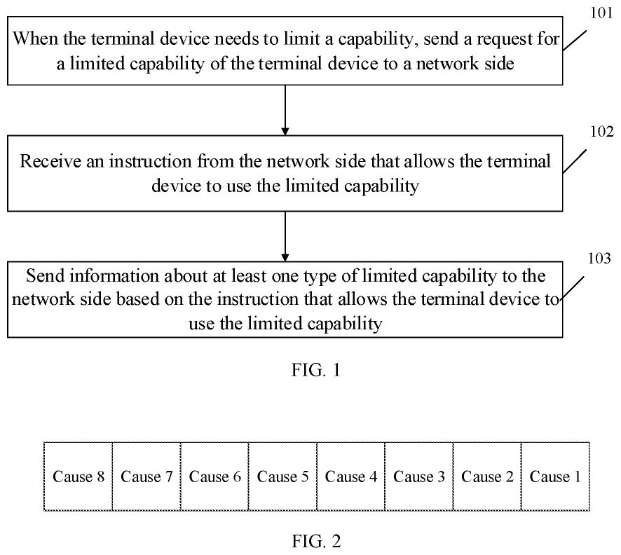

An embodiment of the present disclosure provides a terminal device capability limiting method, which is applied to a terminal device. As shown in FIG. 1, the method includes:

In step 101, when the terminal device needs to limit a capability, a request for a limited capability of the terminal device is sent to a network side.

In step 102, an instruction that allows the terminal device to use the limited capability is received from the network side.

In step 103, information about at least one type of limited capability is sent to the network side based on the instruction that allows the terminal device to use the limited capability.

According to embodiments, the step 101 of sending the request for the limited capability of the terminal device to the network side may include multiple implementation manners. For example, the request for the limited capability of the terminal device may be added in MSG3 or MSG5;

or,

the request for the limited capability of the terminal device may be carried in a Media Access Control (MAC) layer Control Element (CE).

Further, when sending the request for the limited capability, information regarding a cause for the limited capability of the terminal device may also be sent to the network side. For example, the information regarding the cause for the limited capability of the terminal device may be carried in any one of the MSG3, MSG5, and MAC CE.

When setting the cause information for the limited capability in MSG3 or MSG5, a corresponding cause value may be set in a designated field. For example, a cause value of 1 can correspond to insufficient power, and the like. Of course, there can be other cause values and corresponding cause information, and embodiments of the present disclosure do not list all examples.

A data area containing at least one data bit may be set in the MAC CE. Each data bit in the at least one data bit corresponds to information regarding one cause for the limited capability of the terminal device. Based on information regarding a cause for a current limited capability of the terminal device, a target data bit in the data area is set as a target value. That is, the corresponding target data bit is determined based on the cause information, and then the target data bit is set to the corresponding target value. The target value can be set according to actual situations. For example, if the target bit is set to 1, it represents the corresponding cause information.

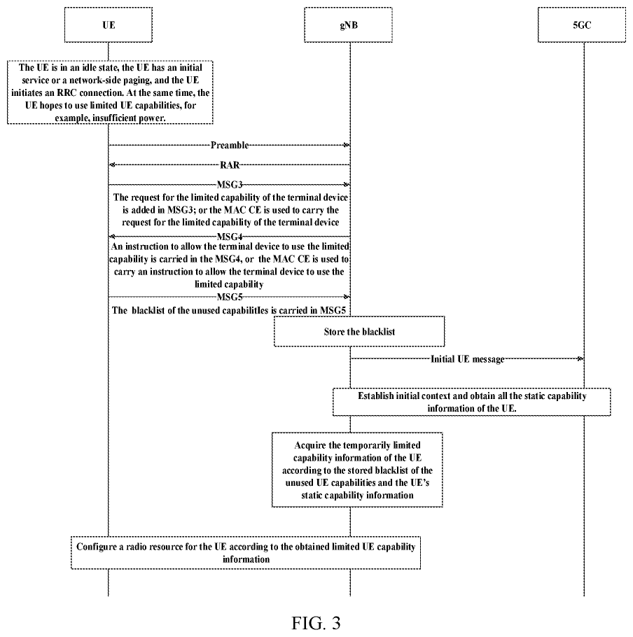

For example, as shown in FIG. 2, a corresponding logical channel ID, i.e., an LCID, is defined in the MAC CE. Each bit of the MAC CE corresponds to a cause for a UE to temporarily limit the UE's capability. For example, the first bit (the first bit is in the low order position) indicates insufficient power, the second bit indicates the cause of interference, and the third bit indicates overheating, and so on. If the corresponding cause triggers the UE to send the request, the corresponding bit is set as 1.

Further, in step 103, sending information about at least one type of limited capability to the network side may include various manners:

Manner 1: list information composed of at least one limited capability is carried in MSG5.

That is, a blacklist method is used to report multiple unused capabilities to the network side.

Manner 2: information about at least one temporarily limited capability of the terminal device is reported to the network side.

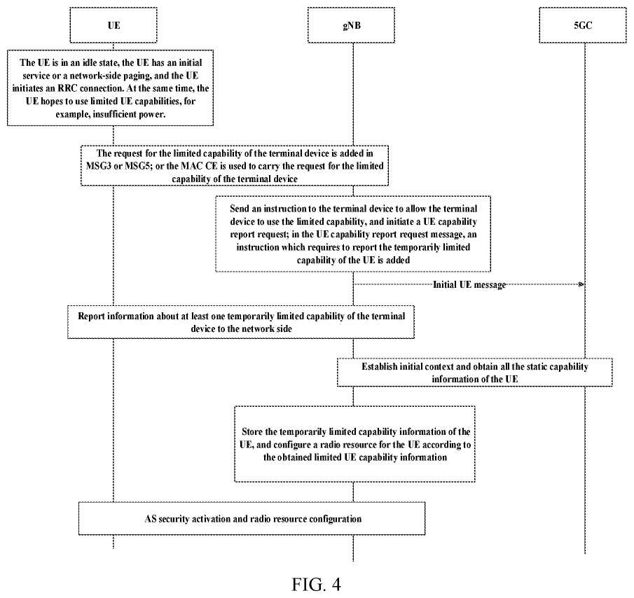

The following provides a detailed description of the solutions provided according to embodiments of the present disclosure with reference to two scenarios provided in FIGS. 3 and 4.

First, referring to FIG. 3, a blacklist-based approach is provided.

The UE is in an idle state, the UE has an initial service or a network-side paging, and the UE initiates an RRC connection. At the same time, the UE hopes to use limited UE capabilities, for example, insufficient power. Thereafter, the UE (i.e., the terminal device) sends an interactive preamble sequence to the network-side base station (gNB), and receives a Random Access Response (RAR) sent by the gNB.

The UE adds the request for the limited capability of the terminal device in MSG3; or uses the MAC CE to carry the request for the limited capability of the terminal device. According to embodiments, the cause information that triggers the limited capability of the terminal device may also be carried, such as interference, insufficient power, overheating, and so on.

The network side carries an instruction to allow the terminal device to use the limited capability in the MSG4, or the network side uses the MAC CE to carry an instruction to allow the terminal device to use the limited capability.

The UE carries list information composed of at least one limited capability in MSG5, that is, a blacklist of unused capabilities.

The base station stores the blacklist of the unused capabilities, and then performs the initial UE message and establishing of the initial context, and obtains all the static capability information of the UE.

The base station acquires the temporarily limited capability information of the UE according to the stored blacklist of the unused UE capabilities and the UE's static capability information.

The base station configures a radio resource for the UE according to the obtained limited UE capability information.

If the blacklist reporting method is used, during the movement of the UE, the previous base station forwards the blacklist of the unused UE capabilities and the UE static capability information to the target base station.

FIG. 4 shows another scenario which is based on a temporarily limited capability reported by the UE.

The UE is in an idle state, the UE has an initial service or a network-side paging, and the UE initiates an RRC connection. At the same time, the UE wants to use limited UE capabilities, such as insufficient power.

The UE adds the request for the limited capability of the terminal device in MSG3 or MSG5, or uses the MAC CE to carry the request for the limited capability of the terminal device. According to embodiments, a cause that triggers the UE to use the temporarily limited capability of the UE may also be carried, such as interference, insufficient power, overheating, and so on. If the MAC CE is used, the MAC CE itself indicates a request for the use of a limited UE capability, and a corresponding logical channel ID, i.e., an LCID, is defined for the MAC CE. Each bit of the MAC CE corresponds to a cause that triggers the UE to use the temporarily limited UE capability. For example, the first bit (the first bit is in the low order position) indicates insufficient power, the second bit indicates the cause of interference, and the third bit indicates overheating, and so on. If the corresponding cause triggers the UE to send the request, the corresponding bit is set as 1.

The base station sends an instruction to the terminal device to allow the terminal device to use the limited capability, and initiates a UE capability report request. In the UE capability report request message, the base station adds an instruction which requires to report the temporarily limited capability of the UE. Then, the initial UE message.

The UE reports information about at least one temporarily limited capability of the terminal device to the network side. Thereafter, the base station performs initial context establishment and obtains all the static capability information of the UE.

The base station stores the temporarily limited capability information of the UE, and configures a radio resource for the UE according to the obtained limited UE capability information. After that, the process of security activation and radio resource configuration is performed between the base station and the UE.

In the technical solutions of embodiments of the present disclosure, the terminal device requests to use temporarily restricted UE capability information, and then reports the temporarily restricted capability information to the network side, so that subsequent processing is triggered on the network side. Thus, embodiments of the present disclosure can achieve power conservation and interference avoidance for the terminal device.

### Second Embodiment

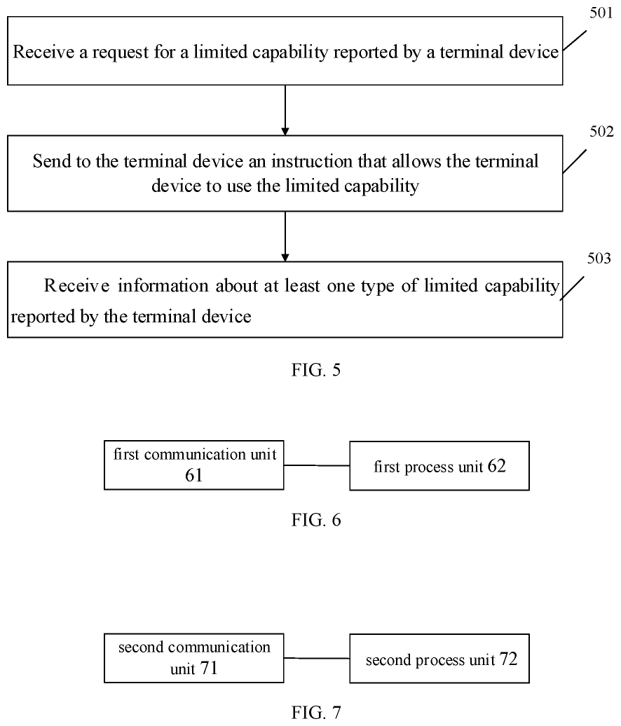

An embodiment of the present disclosure provides a terminal device capability limiting method, which is applied to a network device. As shown in FIG. 5, the method includes:

In step 501, when a terminal device needs to limit a capability, a request for a limited capability reported by the terminal device is received.

In step 502, an instruction that allows the terminal device to use the limited capability is sent to the terminal device.

In step 503, information about at least one type of limited capability reported by the terminal device.

In the embodiment, step 501 of receiving the request for the limited capability reported by the terminal device includes:

obtaining the request for the limited capability of the terminal device in MSG3 or MSG5;

or,

obtaining the request for the limited capability of the terminal device in a Media Access Control (MAC) layer Control Element (CE).

Further, the method may further include: obtaining information regarding a cause for the limited capability of the terminal device in any one of the MSG3, MSG5, and MAC CE.

When setting the cause information for the limited capability in MSG3 or MSG5, a corresponding cause value may be set in a designated field. For example, a cause value of 1 can correspond to insufficient power, and the like. Of course, there can be other cause values and corresponding cause information, and embodiments of the present disclosure do not list all examples.

A data area containing at least one data bit may be detected in the MAC CE. Each data bit in the at least one data bit corresponds to information regarding one cause for the limited capability of the terminal device. Based on that a target data bit in the data area is set as a target value, a cause why a capability of the terminal device is limited is determined.

For example, as shown in FIG. 2, a corresponding logical channel ID, i.e., an LCID, is defined in the MAC CE. Each bit of the MAC CE corresponds to a cause for a UE to temporarily limit the UE's capability. For example, the first bit (the first bit is in the low order position) indicates insufficient power, the second bit indicates the cause of interference, and the third bit indicates overheating, and so on. If the corresponding cause triggers the UE to send the request, the corresponding bit is set as 1.

Sending to the terminal device the instruction that allows the terminal device to use the limited capability may include various manners. For example, the instruction that allows the terminal device to use the limited capability is carried in MSG4, and MSG4 is sent to the terminal device.

Alternatively, as another example, the instruction that allows the terminal device to use the limited capability is carried in the MAC CE and the MAC CE is sent to the terminal device.

The method may further include: storing information about at least one type of limited capability reported by the terminal device; and configuring a corresponding radio resource for the terminal device based on the information about the at least one type of limited capability.

Further, if the terminal device moves to a coverage area of a new base station, the information about at least one type of limited capability of the terminal device is sent to the new base station.

As the terminal device moves and enters the coverage of a new base station, a handover procedure may occur. At this time, information about at least one type of limited capability of the terminal device is directly sent to the new base station, which can reduce signaling interaction between the new base station and the terminal device to exchange capability information again to improve processing efficiency.

The following provides a detailed description of the solutions provided according to embodiments of the present disclosure with reference to two scenarios provided in FIGS. 3 and 4.

First, referring to FIG. 3, a blacklist-based approach is provided.

The UE is in an idle state, the UE has an initial service or a network-side paging, and the UE initiates an RRC connection. At the same time, the UE hopes to use limited UE capabilities, for example, insufficient power. Thereafter, the UE (i.e., the terminal device) sends an interactive preamble sequence to the network-side base station (gNB), and receives a Random Access Response (RAR) sent by the gNB.

The UE adds the request for the limited capability of the terminal device in MSG3; or uses the MAC CE to carry the request for the limited capability of the terminal device. According to embodiments, the cause information that triggers the limited capability of the terminal device may also be carried, such as interference, insufficient power, overheating, and so on.

The network side carries an instruction to allow the terminal device to use the limited capability in the MSG4, or the network side uses the MAC CE to carry an instruction to allow the terminal device to use the limited capability.

The UE carries list information composed of at least one limited capability in MSG5, that is, a blacklist of unused capabilities.

The base station stores the blacklist of the unused capabilities, and then interacts with the 5GC (5G Core, 5G core network), including the initial UE message and the establishment of the initial context and the processing of obtaining all static capability information of the UE.

The base station acquires the temporarily limited capability information of the UE according to the stored blacklist of the unused UE capabilities and the UE's static capability information.

The base station configures a radio resource for the UE according to the obtained limited UE capability information.

If the blacklist reporting method is used, during the movement of the UE, the previous base station forwards the blacklist of the unused UE capabilities and the UE static capability information to the target base station.

FIG. 4 shows another scenario which is based on a temporarily limited capability reported by the UE.

The UE is in an idle state, the UE has an initial service or a network-side paging, and the UE initiates an RRC connection. At the same time, the UE wants to use limited UE capabilities, such as insufficient power.

The UE adds the request for the limited capability of the terminal device in MSG3 or MSG5, or uses the MAC CE to carry the request for the limited capability of the terminal device. According to embodiments, a cause that triggers the UE to use the temporarily limited capability of the UE may also be carried, such as interference, insufficient power, overheating, and so on. If the MAC CE is used, the MAC CE itself indicates a request for the use of a limited UE capability, and a corresponding logical channel ID, i.e., an LCID, is defined for the MAC CE. Each bit of the MAC CE corresponds to a cause that triggers the UE to use the temporarily limited UE capability. For example, the first bit (the first bit is in the low order position) indicates insufficient power, the second bit indicates the cause of interference, and the third bit indicates overheating, and so on. If the corresponding cause triggers the UE to send the request, the corresponding bit is set as 1.

The base station sends an instruction to the terminal device to allow the terminal device to use the limited capability, and initiates a UE capability report request. In the UE capability report request message, the base station adds an instruction which requires to report the temporarily limited capability of the UE. Then, the initial UE message.

The UE reports information about at least one temporarily limited capability of the terminal device to the network side. Thereafter, the base station performs initial context establishment and obtains all the static capability information of the UE.

The base station stores the temporarily limited capability information of the UE, and configures a radio resource for the UE according to the obtained limited UE capability information. After that, the process of security activation and radio resource configuration is performed between the base station and the UE.

In the technical solutions of embodiments of the present disclosure, the terminal device requests to use temporarily restricted UE capability information, and then reports the temporarily restricted capability information to the network side, so that subsequent processing is triggered on the network side. Thus, embodiments of the present disclosure can achieve power conservation and interference avoidance for the terminal device.

### Third Embodiment

An embodiment of the present disclosure provides a terminal device. As shown in FIG. 6, the terminal device includes a first communication unit 61 and a first process unit 62.

The first communication unit 61 is configured to, when the terminal device needs to limit a capability, send a request for a limited capability of the terminal device to a network side, and receive an instruction from the network side that allows the terminal device to use the limited capability.

The first process unit 62 is configured to send information about at least one type of limited capability to the network side via the first communication unit based on the instruction that allows the terminal device to use the limited capability.

According to an embodiment, the first communication unit 61 is configured to add the request for the limited capability of the terminal device in MSG3 or MSG5;

or,

the first communication unit 61 is configured to carry the request for the limited capability of the terminal device in a Media Access Control (MAC) layer Control Element (CE).

Further, when sending the request for the limited capability, information regarding a cause for the limited capability of the terminal device may also be sent to the network side. For example, the first process unit 62 is configured to carry information regarding a cause for the limited capability of the terminal device in any one of the MSG3, MSG5, and MAC CE.

When setting the cause information for the limited capability in MSG3 or MSG5, a corresponding cause value may be set in a designated field. For example, a cause value of 1 can correspond to insufficient power, and the like. Of course, there can be other cause values and corresponding cause information, and embodiments of the present disclosure do not list all examples.

A data area containing at least one data bit may be set in the MAC CE. Each data bit in the at least one data bit corresponds to information regarding one cause for the limited capability of the terminal device. Based on information regarding a cause for a current limited capability of the terminal device, a target data bit in the data area is set as a target value. That is, the corresponding target data bit is determined based on the cause information, and then the target data bit is set to the corresponding target value. The target value can be set according to actual situations. For example, if the target bit is set to 1, it represents the corresponding cause information.

For example, as shown in FIG. 2, a corresponding logical channel ID, i.e., an LCID, is defined in the MAC CE. Each bit of the MAC CE corresponds to a cause for a UE to temporarily limit the UE's capability. For example, the first bit (the first bit is in the low order position) indicates insufficient power, the second bit indicates the cause of interference, and the third bit indicates overheating, and so on. If the corresponding cause triggers the UE to send the request, the corresponding bit is set as 1.

Further, sending information about at least one type of limited capability to the network side may include various manners:

Manner 1: the first communication unit is configured to carry list information composed of at least one limited capability in MSG5.

That is, a blacklist method is used to report multiple unused capabilities to the network side.

Manner 2: the first communication unit is configured to report information about at least one temporarily limited capability of the terminal device to the network side.

The following provides a detailed description of the solutions provided according to embodiments of the present disclosure with reference to two scenarios provided in FIGS. 3 and 4.

First, referring to FIG. 3, a blacklist-based approach is provided.

The UE is in an idle state, the UE has an initial service or a network-side paging, and the UE initiates an RRC connection. At the same time, the UE hopes to use limited UE capabilities, for example, insufficient power. Thereafter, the UE (i.e., the terminal device) sends an interactive preamble sequence to the network-side base station (gNB), and receives a Random Access Response (RAR) sent by the gNB.

The UE adds the request for the limited capability of the terminal device in MSG3; or uses the MAC CE to carry the request for the limited capability of the terminal device. According to embodiments, the cause information that triggers the limited capability of the terminal device may also be carried, such as interference, insufficient power, overheating, and so on.

The network side carries an instruction to allow the terminal device to use the limited capability in the MSG4, or the network side uses the MAC CE to carry an instruction to allow the terminal device to use the limited capability.

The UE carries list information composed of at least one limited capability in MSG5, that is, a blacklist of unused capabilities.

The base station stores the blacklist of the unused capabilities, and then performs the initial UE message and establishing of the initial context, and obtains all the static capability information of the UE.

The base station acquires the temporarily limited capability information of the UE according to the stored blacklist of the unused UE capabilities and the UE's static capability information.

The base station configures a radio resource for the UE according to the obtained limited UE capability information.

If the blacklist reporting method is used, during the movement of the UE, the previous base station forwards the blacklist of the unused UE capabilities and the UE static capability information to the target base station.

FIG. 4 shows another scenario which is based on a temporarily limited capability reported by the UE.

The UE is in an idle state, the UE has an initial service or a network-side paging, and the UE initiates an RRC connection. At the same time, the UE wants to use limited UE capabilities, such as insufficient power.

The UE adds the request for the limited capability of the terminal device in MSG3 or MSG5, or uses the MAC CE to carry the request for the limited capability of the terminal device. According to embodiments, a cause that triggers the UE to use the temporarily limited capability of the UE may also be carried, such as interference, insufficient power, overheating, and so on. If the MAC CE is used, the MAC CE itself indicates a request for the use of a limited UE capability, and a corresponding logical channel ID, i.e., an LCID, is defined for the MAC CE. Each bit of the MAC CE corresponds to a cause that triggers the UE to use the temporarily limited UE capability. For example, the first bit (the first bit is in the low order position) indicates insufficient power, the second bit indicates the cause of interference, and the third bit indicates overheating, and so on. If the corresponding cause triggers the UE to send the request, the corresponding bit is set as 1.

The base station sends an instruction to the terminal device to allow the terminal device to use the limited capability, and initiates a UE capability report request. In the UE capability report request message, the base station adds an instruction which requires to report the temporarily limited capability of the UE. Then, the initial UE message.

The UE reports information about at least one temporarily limited capability of the terminal device to the network side. Thereafter, the base station performs initial context establishment and obtains all the static capability information of the UE.

The base station stores the temporarily limited capability information of the UE, and configures a radio resource for the UE according to the obtained limited UE capability information. After that, the process of security activation and radio resource configuration is performed between the base station and the UE.

In the technical solutions of embodiments of the present disclosure, the terminal device requests to use temporarily restricted UE capability information, and then reports the temporarily restricted capability information to the network side, so that subsequent processing is triggered on the network side. Thus, embodiments of the present disclosure can achieve power conservation and interference avoidance for the terminal device.

### Fourth Embodiment

An embodiment of the present disclosure provides a network device. As shown in FIG. 7, the network device includes a second communication unit 71.

The second communication unit 71 is configured to receive a request for a limited capability reported by a terminal device, send to the terminal device an instruction that allows the terminal device to use the limited capability; and receive information about at least one type of limited capability reported by the terminal.

According to an embodiment, the second communication unit 71 is configured to obtain the request for the limited capability of the terminal device in MSG3 or MSG5;

or,

the second communication unit 71 is configured to obtain the request for the limited capability of the terminal device in a Media Access Control (MAC) layer Control Element (CE).

Further, the network device further includes a second process unit 72.

The second process unit 72 is configured to obtain information regarding a cause for the limited capability of the terminal device in any one of the MSG3, MSG5, and MAC CE.

When setting the cause information for the limited capability in MSG3 or MSG5, a corresponding cause value may be set in a designated field. For example, a cause value of 1 can correspond to insufficient power, and the like. Of course, there can be other cause values and corresponding cause information, and embodiments of the present disclosure do not list all examples.

A data area containing at least one data bit may be detected in the MAC CE. Each data bit in the at least one data bit corresponds to information regarding one cause for the limited capability of the terminal device. Based on that a target data bit in the data area is set as a target value, a cause why a capability of the terminal device is limited is determined.

For example, as shown in FIG. 2, a corresponding logical channel ID, i.e., an LCID, is defined in the MAC CE. Each bit of the MAC CE corresponds to a cause for a UE to temporarily limit the UE's capability. For example, the first bit (the first bit is in the low order position) indicates insufficient power, the second bit indicates the cause of interference, and the third bit indicates overheating, and so on. If the corresponding cause triggers the UE to send the request, the corresponding bit is set as 1.

Sending to the terminal device the instruction that allows the terminal device to use the limited capability may include various manners. For example, the second communication unit 71 is configured to carry the instruction that allows the terminal device to use the limited capability in MSG4, and send the MSG4 to the terminal device;

or,

the second communication unit 71 is configured to carry the instruction that allows the terminal device to use the limited capability in the MAC CE and send the MAC CE to the terminal device.

The second process unit 72 is configured to store information about at least one type of limited capability reported by the terminal device; and configure a corresponding radio resource for the terminal device based on the information about the at least one type of limited capability.

Further, if the terminal device moves to a coverage area of a new base station, the information about at least one type of limited capability of the terminal device is sent to the new base station.

As the terminal device moves and enters the coverage of a new base station, a handover procedure may occur. At this time, information about at least one type of limited capability of the terminal device is directly sent to the new base station, which can reduce signaling interaction between the new base station and the terminal device to exchange capability information again to improve processing efficiency.

In the technical solutions of embodiments of the present disclosure, the terminal device requests to use temporarily restricted UE capability information, and then reports the temporarily restricted capability information to the network side, so that subsequent processing is triggered on the network side. Thus, embodiments of the present disclosure can achieve power conservation and interference avoidance for the terminal device.

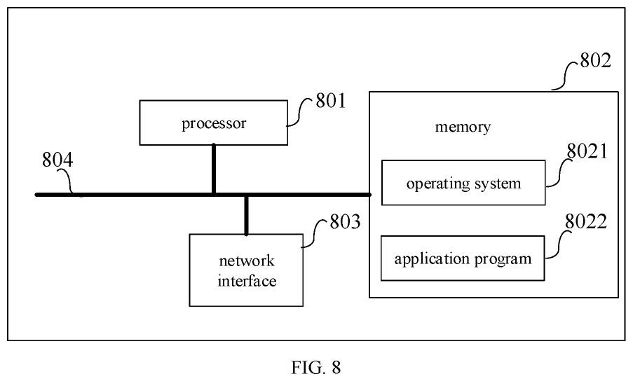

An embodiment of the present disclosure also provides a hardware architecture of a terminal device or a network device. As shown in FIG. 8, at least one processor 801, a memory 802, and at least one network interface 803 are included. Various components are coupled together via a bus system 804. It can be understood that the bus system 804 is used to implement connection and communication between these components. The bus system 804 includes a power bus, a control bus, and a status signal bus in addition to a data bus. However, for the sake of clarity, various buses are marked as the bus system 804 in FIG. 8.

It can be understood that the memory 802 in the embodiment of the present disclosure may be a volatile memory or a non-volatile memory, or may include both volatile and non-volatile memory.

In some implementations, the memory 802 stores the following elements, executable modules or data structures, or their subsets, or their extended sets:

operating system 8021 and application 8022.

The processor 81 is configured to execute all the method steps described in the First Embodiment or the Second Embodiment, and details are not described herein again.

An embodiment of the present disclosure provides a computer storage medium. The computer storage medium stores computer-executable instructions, and when the computer-executable instructions are executed, the method steps of the foregoing First Embodiment or Second Embodiment are implemented.

In the embodiments of the present disclosure, if the foregoing devices are implemented in the form of software functional modules and sold or used as an independent product, they may also be stored in a computer-readable storage medium. Based on such an understanding, the essence of the technical solutions of the embodiments of the present disclosure or the part of the technical solutions of the embodiments of the present disclosure that contributes to the existing technologies can be embodied in the form of a software product. The computer software product is stored in a storage medium and includes instructions to enable a computer device (which may be a personal computer, a server, or a network device) to execute all or part of the methods described in the embodiments of the present disclosure. The foregoing storage medium includes various media that can store program codes, such as a U disk, a mobile hard disk, a read only memory (ROM), a magnetic disk, or an optical disk. The embodiments of the present disclosure are not limited to any specific combination of hardware and software.

Accordingly, an embodiment of the present disclosure further provides a computer storage medium in which computer programs are stored. The computer programs are configured to execute the data scheduling method according to the embodiments of the present disclosure.

Although the exemplary embodiments of the present disclosure have been disclosed for illustrative purposes, those skilled in the art will recognize that various improvements, additions, and substitutions are also possible, and therefore, the scope of the present disclosure should not be limited to the above embodiments.

1. A terminal device capability limiting method, applied to a terminal device and comprising:
when the terminal device needs to limit a capability, sending a request for a limited capability of the terminal device to a network side;
receiving an instruction from the network side that allows the terminal device to use the limited capability; and
sending information about at least one type of limited capability to the network side based on the instruction that allows the terminal device to use the limited capability.

2. The method according to claim 1, wherein sending the request for the limited capability of the terminal device to the network side comprises:
adding the request for the limited capability of the terminal device in MSG3 or MSG5.

3. The method according to claim 1, wherein sending the request for the limited capability of the terminal device to the network side comprises:
carrying the request for the limited capability of the terminal device in a Media Access Control (MAC) layer Control Element (CE).

4. The method according to claim 2, further comprising:
carrying information regarding a cause for the limited capability of the terminal device in any one of the MSG3, MSG5, and MAC CE.

5. The method according to claim 4, further comprising:
setting a data area containing at least one data bit in the MAC CE; wherein each data bit in the at least one data bit corresponds to information regarding one cause for the limited capability of the terminal device; and
based on information regarding a cause for a current limited capability of the terminal device, setting a target data bit in the data area as a target value.

6. The method according to claim 1, wherein sending information about at least one type of limited capability to the network side comprises:
carrying list information composed of at least one limited capability in MSG5.

7. The method according to claim 1, wherein sending information about at least one type of limited capability to the network side comprises:
reporting information about at least one temporarily limited capability of the terminal device to the network side.

8. A terminal device capability limiting method, applied to a network device and comprising:
receiving a request for a limited capability reported by a terminal device;
sending to the terminal device an instruction that allows the terminal device to use the limited capability; and
receiving information about at least one type of limited capability reported by the terminal device.

9. The method according to claim 8, wherein receiving the request for the limited capability reported by the terminal device comprises:
obtaining the request for the limited capability of the terminal device in MSG3 or MSG5.

10. The method according to claim 9, wherein sending to the terminal device the instruction that allows the terminal device to use the limited capability comprises:
carrying the instruction that allows the terminal device to use the limited capability in MSG4 and sending the MSG4 to the terminal device.

11. The method according to claim 8, wherein receiving the request for the limited capability reported by the terminal device comprises:
obtaining the request for the limited capability of the terminal device in a Media Access Control (MAC) layer Control Element (CE).

12. The method according to claim 11, wherein sending to the terminal device the instruction that allows the terminal device to use the limited capability comprises:
carrying the instruction that allows the terminal device to use the limited capability in the MAC CE and sending the MAC CE to the terminal device.

13. The method according to claim 9, further comprising:
obtaining information regarding a cause for the limited capability of the terminal device in any one of the MSG3, MSG5, and MAC CE.

14. The method according to claim 13, further comprising:
detecting a data area containing at least one data bit in the MAC CE; wherein each data bit in the at least one data bit corresponds to information regarding one cause for the limited capability of the terminal device; and
based on that a target data bit in the data area is set as a target value, determining a cause why a capability of the terminal device is limited.

15. The method according to claim 8, further comprising:
storing information about at least one type of limited capability reported by the terminal device; and
configuring a corresponding radio resource for the terminal device based on the information about the at least one type of limited capability.

16. The method according to claim 8, further comprising:
if the terminal device moves to a coverage area of a new base station, sending the information about at least one type of limited capability of the terminal device to the new base station.

17. A terminal device, comprising:
a processor;
a memory for storing computer programs executable by the processor; and
a network interface;
wherein the processor is configured to, when the terminal device needs to limit a capability, send a request for a limited capability of the terminal device to a network side via the network interface, receive an instruction from the network side that allows the terminal device to use the limited capability via the network interface; and send via the network interface information about at least one type of limited capability to the network side based on the instruction that allows the terminal device to use the limited capability.

18. The terminal device according to claim 17, wherein the processor is configured to add the request for the limited capability of the terminal device in MSG3 or MSG5 via the network interface.

19. The terminal device according to claim 17, wherein the processor is configured to carry the request for the limited capability of the terminal device in a Media Access Control (MAC) layer Control Element (CE) via the network interface.

20. The terminal device according to claim 18, wherein the processor is configured to carry information regarding a cause for the limited capability of the terminal device in any one of the MSG3, MSG5, and MAC CE.

21.-35. (canceled)
